(19) United States
(12) Patent Application Publication
(10) Pub. No.: US 2002/0008707 A1
(43) Pub. Date: Jan. 24, 2002

(54) On screen display circuit and image display circuit

(75) Inventor: Atsushi Ido, Kawasaki-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-Shi (JP)

(21) Appl. No.: 09/880,031

(22) Filed: Jun. 14, 2001

(30) Foreign Application Priority Data
Jun. 14, 2000 (JP) 2000-178519

(51) Int. Cl. G09G 5/02

(52) U.S. Cl. 345/589

(57) ABSTRACT

A color signal generating circuit which receives 2-bit digital data, forms one of three or more different outputs on the basis of the digital data, and outputs it as a color display signal is used. An I signal generating circuit having a similar arrangement is used to superpose the color display signal and an I signal. This makes it possible to reliably and easily display multiple gray levels and multiple colors with a simple arrangement.

### CROSS REFERENCE TO RELATED APPLICATION

This application claims benefit of priority under 35 USC 119 to Japanese Patent Application No. 2000-178519, filed on Jun. 14, 2000, the entire contents of which are incorporated by reference herein.

### BACKGROUND OF THE INVENTION

The present invention relates to an On Screen Display (to be referred to as “OSD” hereinafter) circuit and image display circuit and, more particularly, to an OSD circuit and image display circuit capable of displaying multicolor information on various image display devices such as a CRT and a liquid crystal display (LCD), on the basis of output data from a microprocessor or any other data supply source.

Video display processors such as a television receiver using a CRT, LCD, or PDP (plasma image display) and a monitor display used in a personal computer are required to display high-quality images by using an OSD circuit. For example, various pieces of information such as a channel currently being displayed and the present time are sometimes displayed on the corners of a television image on a television receiver. These pieces of information are displayed by generating a video signal for information display by using an OSD circuit controlled by a microprocessor, and appropriately switching a television image analog video signal and the information display video signal.

FIGS. 10A and 10B are conceptual views for explaining an outline of the main parts arrangement and operation of an OSD circuit related to the present invention. That is, the circuit shown in FIG. 10A is a portion of an OSD circuit for controlling color signals of R (red), G (green), and B (blue), and this portion controls one of these color signals. The circuit includes a color designating register 100, a control circuit 110, a p-channel transistor 120, and an n-channel transistor 130. The transistors 120 and 130 are connected in series between, e.g., low and high potentials.

The color designating register 100 stores 1-bit digital data corresponding to one of the R, G, and B color signals. This digital data is input to the control circuit 110, and the control circuit 110 outputs control signals to the transistors 120 and 130 in accordance with the input data.

FIG. 11 is a circuit diagram showing a practical arrangement of the control circuit 110. That is, this control circuit 110 can be constructed by an inverter 110A.

The operation of the above circuit will be explained with reference to FIG. 10B. First, when the digital data stored in the color designating register 100 is “0 (zero)”, the p-channel transistor 120 is “OFF” and the n-channel transistor 130 is “ON”, so the level of the color display signal is “0” or “low level”.

When the digital data in the color designating register 100 is “1”, the p-channel transistor 120 is “ON” and the n-channel transistor 130 is “OFF”, so the level of the color display signal is “1” or “high level”.

The two types of color display signals thus formed are input to a video processor (not shown) connected to the output of the OSD circuit, and an image corresponding to the digital data is displayed in a predetermined position on the screen.

The OSD circuit as shown in FIG. 10A is provided for each of R (red), G (green), and B (blue), and forms two different R, G, or B display signals on the basis of 1-bit digital R, G, or B data.

Since the two different display signals are formed for each of R, G, and B by the OSD circuits, a total of eight combinations, i.e., eight colors can be displayed.

As described above, the OSD circuits related to the present invention display eight colors on the basis of 1-bit digital R, G, and B data.

The eight display colors, however, are lacking power of expression.

To display a larger number of gray levels, therefore, it is possible to increase the number of bits of digital data and form digital-to-analog converters (DACs) in the OSD circuits accordingly.

However, this method increases the cost. That is, since the digital RGB data is represented by a binary signal “1” or “0”, the data must be converted into an analog signal of a predetermined level by a DAC in order to output a signal of an intermediate luminance. To set a plurality of intermediate luminance levels, it is necessary to complicate the DAC configuration and increase the circuit scale.

### SUMMARY OF THE INVENTION

It is, therefore, an object of the present invention to provide an OSD circuit and image display circuit capable of reliably and easily displaying multiple gray levels and multiple colors with a simple configuration.

An on screen display circuit of the present invention comprises a color signal generating circuit for receiving 2-bit digital data, forming one of three or more different outputs on the basis of the digital data, and outputting it as a color display signal.

The circuit can further comprise an I signal generating circuit for receiving 2-bit digital data, forming one of three or more different outputs on the basis of the digital data, and outputting it as an I signal to be superposed on the color display signal.

The circuit can further comprise a circuit for superposing the color display signal and the I signal.

The superposing circuit can comprise a first input terminal connected to an output terminal of the color signal generating circuit, a second input terminal connected to an output terminal of the I signal generating circuit, an output terminal for outputting a superposition signal formed by superposing the color display signal and the I signal, a first resistor connected between the first input terminal and the output terminal, a second resistor having one terminal connected to the output terminal, a third resistor having one terminal connected to the second input terminal, and a switching element having one terminal connected to the other terminal of the second resistor, the other terminal connected to ground, and a control terminal connected to the other terminal of the third resistor. The I signal can be input to the control terminal to control an opening/closing operation of the switching element, thereby superposing the I signal on the color display signal and outputting the superposition signal from the output terminal.

It is possible to use a 3-value-output circuit by which the three or more different outputs are a low level, a high level, and a high impedance.

The number of display gray levels can be further increased by using a 4-value-output circuit by which the three or more different outputs are a low level, a high level, a high impedance, and a fourth level higher than the low level and lower than the high level.

The number of display gray levels can be greatly increased by using the color signal generating circuit for each of R, G, and B.

An image display circuit of the present invention comprises a CPU for outputting a select signal and port output data, one of the on screen display circuits described above, and a selector for supplying one of the 2-bit digital data and the port output data to the color signal generating circuit on the basis of the select signal, wherein the color signal generating circuit outputs the color signal when supplied with the 2-bit digital data from the selector, and forms one of not less than three outputs on the basis of the port output data, when supplied with the port output data from the selector, and outputs it as a port output signal.

With the above arrangement, a color display signal and a port output signal can be formed by a common color signal generating circuit. This can simplify the circuit configuration and at the same time greatly increase the number of display gray levels.

### BRIEF DESCRIPTION OF THE DRAWINGS

FIGS. 1A and 1B are conceptual views for explaining the arrangement and operation of main part of an OSD circuit according to the first embodiment of the present invention;

FIG. 2 is a circuit diagram showing a practical example of the OSD circuit according to the first embodiment of the present invention;

FIGS. 3A and 3B are conceptual views for explaining the arrangement and operation of main part of an OSD circuit according to the second embodiment of the present invention;

FIGS. 4A, 4B, and 4C are circuit diagrams showing practical examples of the configuration of a voltage conversion circuit according to the second embodiment of the present invention;

FIGS. 5A, 5B, and 5C are circuit diagrams showing practical examples of the configuration of the voltage conversion circuit according to the second embodiment of the present invention;

FIG. 6 is a conceptual view showing an outline of the arrangement of a circuit for superposing the same I signal on R, G, and B color display signals;

FIGS. 7A and 7B are conceptual views for explaining the arrangement and operation of main part of an OSD circuit according to the third embodiment of the present invention;

FIG. 8 is a conceptual view showing the whole configuration of an OSD circuit according to the fourth embodiment of the present invention;

FIG. 9 is a conceptual view showing the entire arrangement of an image display circuit according to the fourth embodiment of the present invention;

FIGS. 10A and 10B are conceptual views for explaining an outline of the arrangement and operation of main part of a conventional OSD circuit; and

FIG. 11 is a circuit diagram showing a practical arrangement of a control circuit 110.

### DESCRIPTION OF THE PREFERRED EMBODIMENTS

Preferred embodiments of the present invention will be described below with reference to the accompanying drawings.

(First Embodiment)

As the first embodiment of the present invention, an OSD circuit including a “2-bit-input, 3-value-output circuit” will be described below.

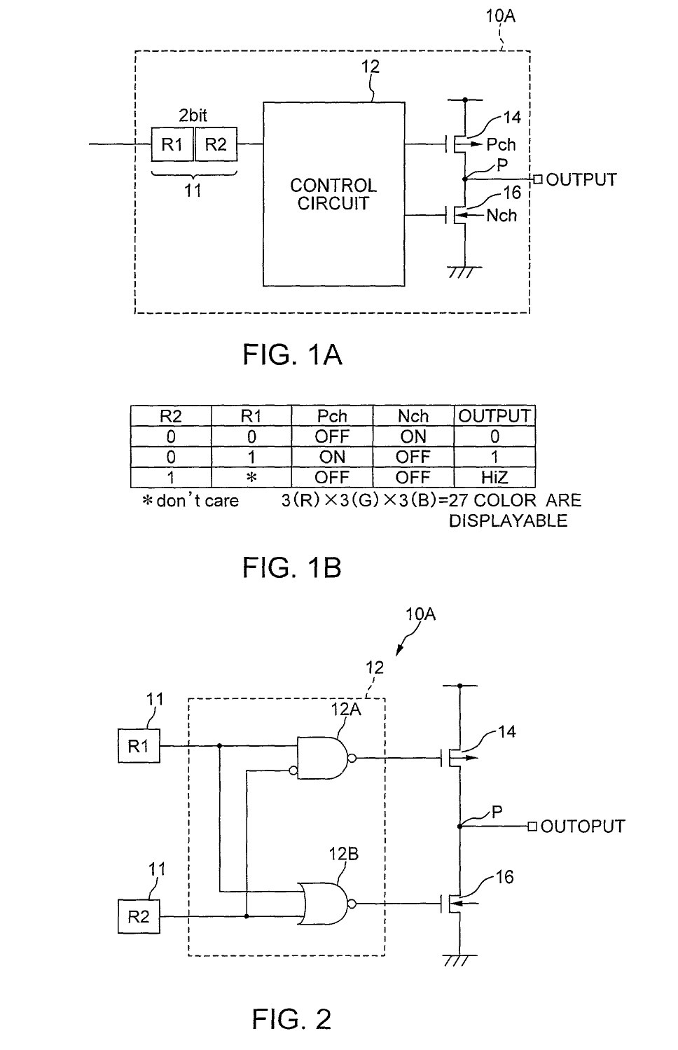

FIG. 1A is a conceptual view for explaining the arrangement and operation of main part of the OSD circuit according to this embodiment. That is, a circuit 10A shown in FIG. 1A is a portion of an OSD circuit for controlling color signals of R (red), G (green), and B (blue), and this portion forms a color display signal of one of these colors. This circuit 10A comprises a color designating register 11 for storing 2-bit digital data, a control circuit 12, a p-channel transistor 14, and an n-channel transistor 16. The transistors 14 and 16 are connected in series between low and high potentials, e.g., 0 and 5 volts.

The color designating register 11 has registers R1 and R2 each for storing one bit of the 2-bit digital data corresponding to the color signal of one of R, G, and B. This digital data is input to the control circuit 12, and the control circuit 12 outputs control signals to the transistors 14 and 16 in accordance with the input digital data.

A node p as an intermediate connection point between the transistors 14 and 16 outputs a color display signal.

The operation of the above circuit will be described below with reference to FIG. 1B. First, when the data stored in the color designating register R2 is “0” and the data stored in the register R1 is “0”, the p-channel transistor 14 is “OFF”, the n-channel transistor 16 is “ON”, and the level of the color display signal is “0” or “low level”.

When the data in the color designating register R2 is “0” and the data in the register R1 is “1”, the p-channel transistor 14 is “ON”, the n-channel transistor 16 is “OFF”, and the level of the color display signal is “1” or “high level”.

Furthermore, when the data in the color designating register R2 is “1”, both the p- and n-channel registers 14 and 16 are “OFF” regardless of the data in the register R1, and the level of the color display signal is “HiZ (high impedance)”.

That is, the OSD circuit of the present invention includes a color signal generating circuit which forms three color display signals “0”, “1”, and “HiZ” on the basis of the 2-bit digital data. The three color display signals thus formed are input to a video processing circuit (not shown) included in or connected to the output stage of the OSD circuit. An image corresponding to the digital data is displayed in a predetermined position on the screen.

The OSD circuit as shown in FIGS. 1A and 1B is provided for each of R (red), G (green), and B (blue), and each of these OSD circuits forms three different color display signals of R G, or B on the basis of 2-bit digital data of R, G, or B.

That is, these OSD circuits form three different display signals for each of R, G, and B. Accordingly, a total of 3×3×3=27 combinations, i.e., 27 colors or 27 gray levels can be displayed.

As described above, the OSD circuits of this embodiment can display 27 colors on the basis of 2-bit digital R, G, and B data.

FIG. 2 is a circuit diagram showing a practical example of the OSD circuit of this embodiment. That is, the control circuit 12 is composed of an AND gate 12A and an OR gate 12B, and the data of the color designating registers R1 and R2 are input to the AND gate 12A and the OR gate 12B, respectively. In this way, the operation described above in connection with FIGS. 1A and 1B can be realized. As shown in FIG. 2, this embodiment makes it possible to display 27 colors with an extremely simple arrangement. Even when compared to the OSD circuit shown in FIG. 11 related to the present invention, the number of color display gray levels can be greatly increased with a slight circuit change.

The circuit shown in FIG. 2 is merely an example as a practical configuration of this embodiment, and the same effect can be obtained by other various circuit configurations.

(Second Embodiment)

As the second embodiment of the present invention, an OSD circuit further including a “2-bit-input, 3-value-output” I signal generating circuit will be described below.

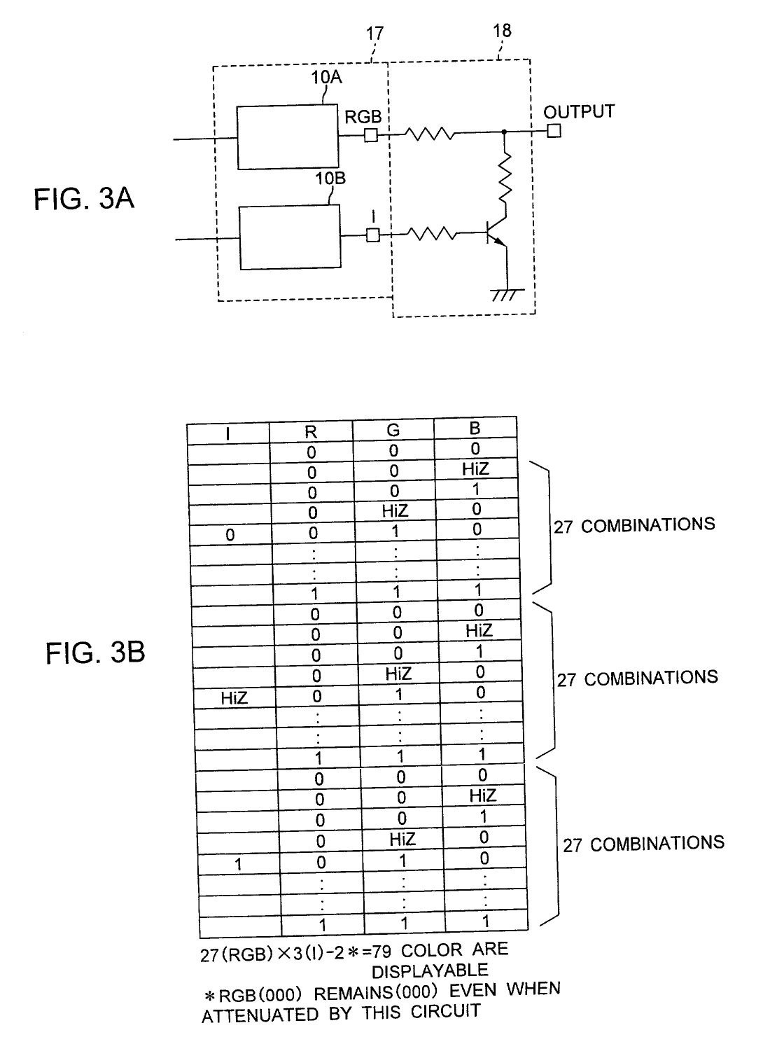

FIGS. 3A and 3B are conceptual views for explaining the arrangement and operation of main part of the OSD circuit according to this embodiment. That is, the OSD circuit of this embodiment has a signal generator 17 which includes a 2-bit-input, 3-value-output color signal generating circuit 10A described previously in the first embodiment, and a 2-bit-input, 3-value-output I signal generating circuit 10B. An I signal is a signal to be superposed on a color display signal formed by the color signal generating circuit 10A. By thus superposing the I signal, it is possible to attenuate R, G, and B color display signals and further increase the number of display gray levels.

The circuit configuration of the I signal generating circuit 10B can be the same as the color signal generating circuit 10A shown in FIG. 1A or 2, so this configuration is not shown. That is, similar to the color signal generating circuit 10A, the I signal generating circuit 10B receives 2-bit digital data, holds the data in registers of two bits, and causes a control circuit to output a 3-bit I signal (0, 1, and high impedance).

A connecting circuit 18 for superposing the I signal can be formed as part of the OSD circuit or as a circuit separated from the OSD circuit.

FIG. 3B shows combinations obtained when a common I signal is superposed on R, G, and B color display signals. As shown in FIG. 3B, R, G, and B color display signals output from the 2-bit-input, 3-value-output color signal generating circuit 10A have three levels “0”, “1”, and “HiZ”. Therefore, a total of 3×3×3=27 combinations are obtained by these R, G, and B signals. That is, 27 colors or 27 gray levels can be displayed by a 6-bit input.

By superposing three different I signals “0”, “1”, and “HiZ” on these 27 colors, 27 (RGB)×3 (I)−2=79 colors can be expressed. “2” is subtracted in this equation because when R, G, and B color display signals are (000), these display signals remain (000) even if attenuated in accordance with I=“1” and “HiZ”, so the tone does not change.

In the present invention as described above, 79 colors can be expressed by superposing the I signal obtained from 2-bit data onto R, G, and B color display signals obtained from 6-bit data.

The RGB display and I signal obtained as explained can be converted into desired analog potentials by using a voltage conversion circuit which uses voltage dividing resistors.

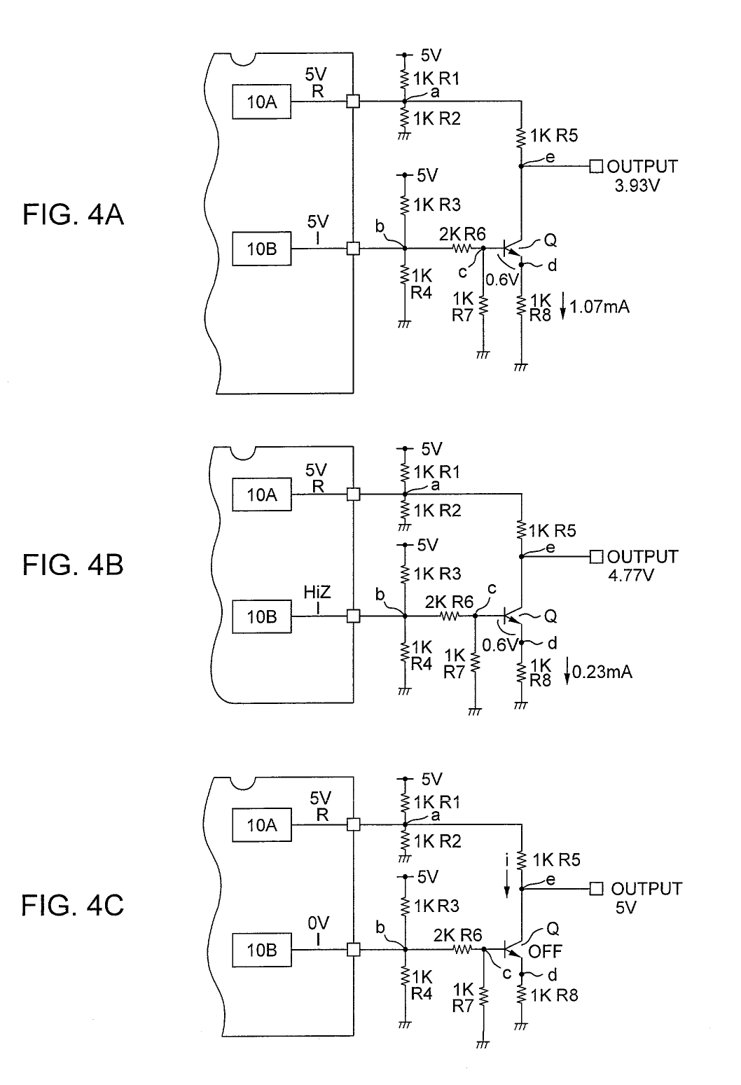

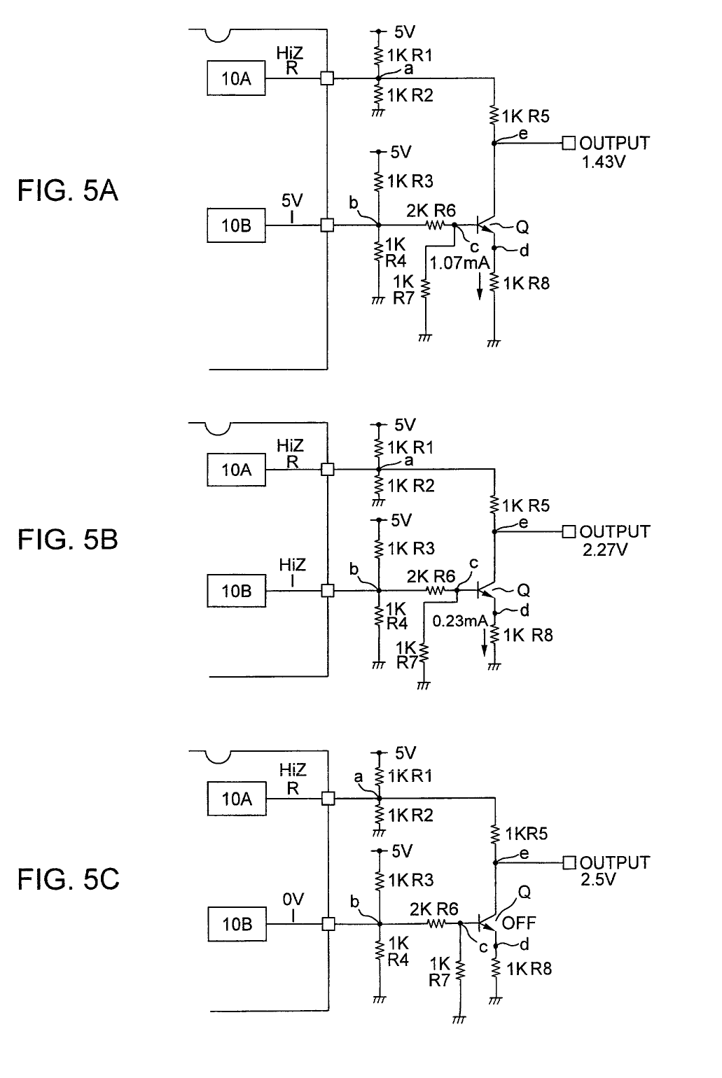

FIGS. 4A to 5C are circuit diagrams showing examples of practical arrangements of this voltage conversion circuit. In each of these circuits shown in FIGS. 4A to 5C, the output from the color signal generating circuit 10A for forming an R (or G or B) display signal is first connected to the intermediate connection point between voltage dividing resistors R1 and R2 connected in series between 5 V and the ground potential, and then connected to the collector of a transistor Q via resistors R5.

The output from the 2-bit-input, 3-value-output I signal generating circuit 10B for forming an I output is connected to the intermediate connection point between voltage dividing resistors R3 and R4 connected in series between 5 V and the ground potential, and connected to the base of the transistor Q via a resistor R6. The base of the transistor Q is connected to the ground potential via a resistor R7. The emitter of the transistor Q is connected to the ground potential via a resistor R8.

A display signal on which the I signal is superposed is formed at the intermediate connection point between the resistor R5 and the transistor Q.

In the present invention, the voltage conversion circuit as shown in each of FIGS. 4A to 5C can be formed as part of the OSD circuit or as a circuit separated from the OSD circuit.

Practical operations when the resistance values of the voltage dividing resistors are set as shown in FIGS. 4A to 5C will be described below.

First, an operation when the output display signal from the color signal generating circuit 10A is 5 V and the output I signal from the I signal generating circuit 10B is also “1”, i.e., 5 V will be explained. In this case, the voltages of nodes a and b are 5 V regardless of the values of the voltage dividing resistors R3 and R4. Accordingly, the voltage dividing resistors R6, R7 produce a voltage drop. As a consequence, a voltage of 1.67V is generated at a node c. The transistor Q is turned on, and a voltage VBE between the base and emitter of this transistor Q is 0.6 V.

Accordingly, the transistor Q produces a voltage drop of 0.6V. As a consequence, a voltage of 1.07V is generated at a node d. As a result, a voltage of 1.07V is applied to the voltage dividing resistor R8, and an electric current of 1.07 mA flows through it. A current i flowing through this resistor R8 is equal to a current flowing through the resistor R5 from the current path of the transistor Q, i.e., the node a, so an electric current of 1.07 mA also flows through the resistor R5. Accordingly, the resistor R5 produces a voltage drop of 1 k (Ω)×1.07 (mA)=1.07 V. As a consequence, a voltage of (5-1.07)=3.93V is generated at a node e, i.e., an output point.

As described above, by superposing an I signal of “1”, e.g., 5 V on the R, G, and B color display signals, it is possible to attenuate the output level and increase the number of display gray levels.

An operation when the color display signal is 5 V and the I signal is “HiZ” will be described below with reference to FIG. 4B. In this case, the voltage at the node a is 5 V and the voltage at the node b is 2.5 V. Accordingly, the voltage dividing resistors R6, R7 produce a voltage drop. As a consequence, a voltage of 0.83V is generated at a node c. The transistor Q is turned on, and the voltage VBE between the base and emitter of this transistor Q is 0.6 V.

Accordingly, the transistor Q produces a voltage drop of 0.6 V. As a consequence, a voltage of 0.23V is generated at a node d. A voltage of 0.23 V is applied to the resistor R8, and an electric current of 0.23 mA flows through it. Therefore, an electric current flowing through the resistor R5 from the node a is also 0.23 mA, and the resistor R5 produces a voltage drop of 1 k (Ω)×0.23 (mA)=0.23V. Consequently, a voltage of (5-0.23)=4.77 V is generated at the node d, i.e., at the output point.

As described above, by superposing an I signal of “HiZ” on the R, G, and B color display signals, it is possible to properly attenuate the output level and increase the number of display gray levels.

An operation when the color display signal is 5 V and the I signal is “0” will be described below with reference to FIG. 4C. In this case, the voltage at the node a is 5 V and the voltage at the node b is 0 V. The transistor Q is turned off, and no electric current flows through the node d from the node a via the resistor R5. Therefore, no voltage drop occurs in the node e, and a voltage of 5 V is output from it.

An operation when the color display signal is “HiZ” and the I signal is “1”, i.e., 5 V will be described below with reference to FIG. 5A. In this case, the voltage at the node a is determined by the voltage dividing resistors R1 and R2. Referring to FIG. 5A, this voltage is 2.5 V. The voltage at the node b is 5 V regardless of the values of the voltage dividing resistors R3 and R4. Accordingly, the voltage dividing resistors R6, R7 produce a voltage drop. As a consequence, a voltage of 1.67V is generated at a node c. The transistor Q is turned on. A voltage of 1.07 V is applied to the resistor R8, and an electric current of 1.07 mA flows through it. As a consequence, an electric current flowing through the resistor R5 from the node a is also 1.07 mA, so the resistor R5 produces a voltage drop of 1 k (Ω)×1.07 (mA)=1.07 V. Accordingly, a voltage of (2.5-1.07)=1.43 V is generated at the node e, i.e., the output point.

An operation when both the display signal and the I signal are “HiZ” will be described below with reference to FIG. 5B. In this case, the voltages at both the nodes a and b are 2.5 V. Accordingly, the voltage dividing resistors R6, R7 produce a voltage drop. As a consequence, a voltage of 0.83 V is generated at a node c. Then transistor Q is turned on. A voltage of 0.23 V is applied to the resistor R8, and an electric current i of 0.23 mA flows through it. Accordingly, an electric current of 0.23 mA flows through the resistors R5 from the node a, and the resistor R5 produces a voltage drop of 1 k (Ω)×0.23 (mA)=0.23 V. As a result, a voltage of (2.5-0.23)=2.27 V is generated at the node d, i.e., the output point.

An operation when the display signal is “HiZ” and the I signal is “0” will be described below with reference to FIG. 5C. In this case, the voltage at the node a is 2.5 V, the voltage at the node b is 0V, and the transistor Q is turned off. Therefore, no electric current flows through the node d from the node a via the resistor R5. So, no voltage drop occurs in the node e, and a voltage of 2.5 V is output from it.

Voltages and currents at the individual points when the circuit 10A outputs “1” or 5 V, “HiZ”, and “0” or 0 V as the display signal and the circuit 10B outputs “1” or 5 V, “HiZ”, and “0” or 0 V as the I signal are summarized as follows.

| RGB display | | Node voltages | | | | Electric | Output |
|---|---|---|---|---|---|---|---|
| signal | I signal | a | b | c | d | current i | voltage e |
| (V) | (V) | (V) | (V) | (V) | (V) | (mA) | (V) |
| 5 | 0 | 5 | 0 | 0 | 0 | 0 | 5 |
| 5 | HiZ | 5 | 2.5 | 0.83 | 0.23 | 0.23 | 4.77 |
| 5 | 5 | 5 | 5 | 1.67 | 1.07 | 1.07 | 3.93 |
| HiZ | 0 | 2.5 | 0 | 0 | 0 | 0 | 2.5 |
| HiZ | HiZ | 2.5 | 2.5 | 0.83 | 0.23 | 0.23 | 2.27 |
| HiZ | 5 | 2.5 | 5 | 1.67 | 1.07 | 1.07 | 1.43 |
| 0 | *** | 0 | *** | *** | *** | 0 | 0 |

As can be seen from the above practical example, it is possible by superposing an I signal of “1” or “HiZ” to appropriately attenuate the R, G, and B display signals and increase the number of display gray levels.

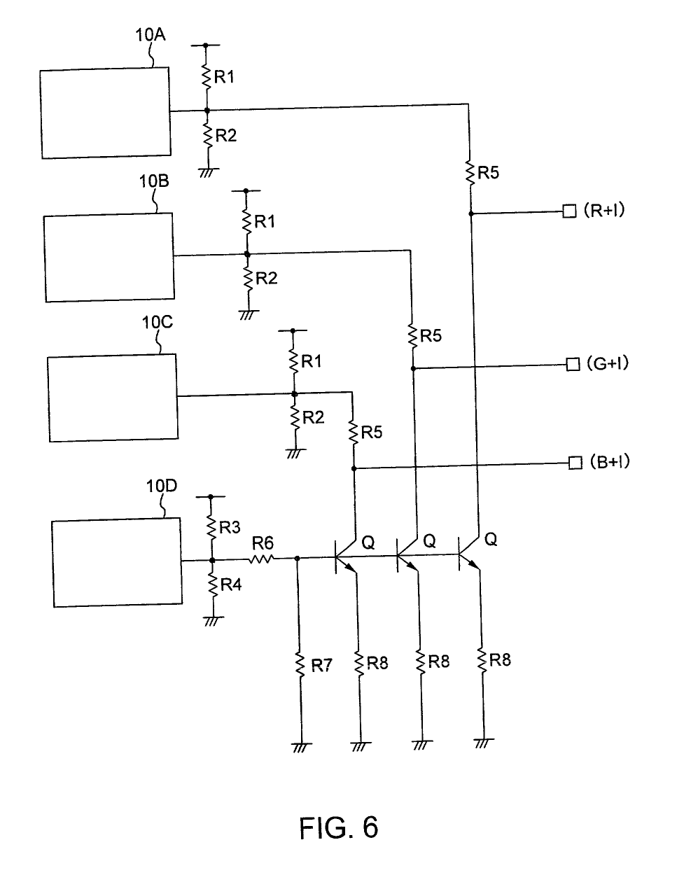

FIG. 6 is a conceptual view showing an outline of the arrangement of a circuit for superposing the same I signal on the R, G, and B color display signals. That is, R, G, and B color display signals are output from 2-bit-input, 3-value-output color signal generating circuits 10A, 10B, and 10C, respectively, and grounded via a middle point of voltage dividing resistors R1, R2 and R5, a transistor Q, a resistor R8. Also, an output I signal from a separately formed 2-bit-input, 3-value-output I signal generating circuit 10D is input parallel to the transistors Q via a middle point of voltage dividing transistors R3, R4, and R6. The base of the transistor Q is connected to the ground potential via a resistor R7.

With this arrangement, the number of gray levels can be increased by superposing the same I signal on the R, G, and B color display signals.

It is also possible to superpose different I signals on the R, G, and B color display signals. That is, three 2-bit-input, 3-value-output color signal generating circuits for supplying the R, G, and B color display signals and three 2-bit-input, 3-value-output I signal generating circuits for outputting the I signals are formed. The I signals output from the different circuits are separately superposed on the R, G, and B color display signals. In this case, the number of combinations (R, I) of the R display signal and the I signal are 7, i.e., (R, I)=(1, 0), (1, HiZ), (1, 1), (HiZ, 0), (HiZ, HiZ), (HiZ, 1), and (0, 0). That is, 7 gray levels can be obtained by superposing the 2-bit R display signal and the 2-bit I signal.

When the I signals are similarly superposed on G and B, a total of (7×7×7)=343 combinations can be obtained. That is, 343 gray levels can be displayed by using 6-bit RGB data and 6-bit I signal data.

(Third Embodiment)

As the third embodiment of the present invention, an OSD circuit including a “2-bit-input, 4-value-output” color signal generating circuit for receiving 2-bit digital data and outputting analog signals of four levels and an I signal generating circuit will be described below.

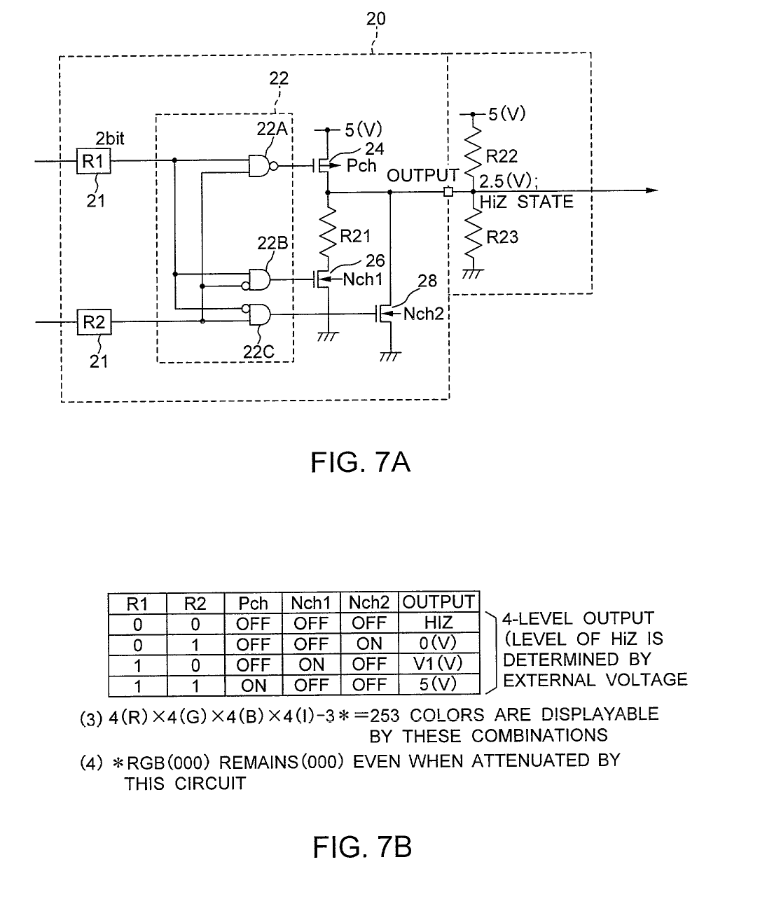

FIGS. 7A and 7B are conceptual views for explaining the arrangement and operation of main part of the OSD circuit according to this embodiment. That is, a circuit 20 shown in FIG. 7A is a portion of an OSD circuit for controlling color signals of R (red), G (green), and B (blue), and this portion controls one of these color signals. This circuit 20 includes a color designating register 21 for storing 2-bit digital data, a control circuit 22, a p-channel transistor 24, n-channel transistors 26 and 28, and a voltage dividing resistor R21. The transistors 24 and 26 are connected in series between, e.g., low and high potentials.

The color designating register 21 has registers R1 and R2 each for storing one bit of 2-bit digital data corresponding to one of R, G, and B color signals. The control circuit 22 has a NAND gate 22A and AND gates 22B and 22C. This control circuit 22 receives the digital data from the register 21 and outputs logical values. These logical values are supplied as control signals to the transistors 24 to 28, and a node p forms a color display signal.

The operation of this circuit will be explained with reference to FIG. 7B. First, when both the data stored in the color designating registers R2 and R1 are “0”, both the p- and n-channel transistors 26 and 28 are “OFF”. As a consequence, the node p outputs “HiZ”.

When the data in the color designating register R2 is “0” and the data in the register R1 is “1”, the p- and n-channel transistors 24 and 26 are “OFF”, and the n-channel transistor 28 is “ON”. Consequently, the potential of the node p becomes level “0”, e.g., “0” V.

When the data in the color designating register R2 is “1” and the data in the register R1 is “0”, the p- and n-channel transistors 24 and 28 are “OFF”, and the n-channel transistor 26 is “ON”. In this case, the potential of the node p becomes a potential “V1” to be applied to the voltage dividing resistor R21.

When both the data in the color designating registers R2 and R1 are “1”, the p-channel transistor 24 is “ON”, the n-channel transistors 26 and 28 are “OFF”, and the potential of the node p becomes level “1”, e.g., “5” V.

As described above, the circuit of this embodiment receives 2-bit digital data and forms color display signals of four levels. Of these color display signals of four levels described above, “HiZ” can be converted into a desired potential by using voltage dividing resistors R22 and R23 as shown in FIG. 7A in the subsequent stage. For example, when these voltage dividing resistors R22 and R23 have equal resistances, it is possible to equally divide an external voltage of 5 V to output 2.5 V in accordance with “HiZ”.

In this embodiment, therefore, in accordance with color display signals of four levels to be formed, i.e., “0”, “V1”, “HiZ”, and “1”, color display signals of four desired levels can be output within the range of, e.g., 0 to 5 V.

When this 2-bit-input, 4-level-output circuit is used in each of R, G, and B color signal generating circuits, 4(R)×4(G)×4(B)=64 combinations are obtained. That is, 64 gray levels can be displayed by data of 2+2+2=6 bits.

In addition, as explained in the second embodiment, an I signal can also be superposed. That is, when I signals of four levels are formed using the 2-bit-input, 4-value-output circuit of this embodiment and superposed on the R, G, and B color display signals, 4(R)×4(G)×4(B)×4(I)−3=253 combinations can be obtained. In other words, 253 gray levels can be displayed by addition of the 2-bit I signal data to the 6-bit RGB data. 3 is subtracted in the above equation because RGB (000) remains (000) and the tone does not change regardless of whether “V1”, “HiZ”, or “1” is superposed as an I signal.

Furthermore, different I signals can also be superposed on the R, G, and B color display signals in this embodiment. That is, three 2-bit-input, 4-value-output color signal generating circuits for supplying the R, G, and B color display signals and three 2-bit-input, 4-value-output I signal generating circuits for outputting the I signals are formed. The I signals output from the different circuits are separately superposed on the R, G, and B color display signals. In this case, the number of combinations (R, I) of the R display signal and the I signal are 13, i.e., (R, I)=(1, 0), (1, V1), (1, HiZ), (1, 1), (HiZ, 0), (HiZ, V1), (HiZ, HiZ), (HiZ, 1), (V1, 0), (V1, V1), (V1, HiZ), (V1, 1), and (0, 0). That is, 13 gray levels can be obtained by superposing the 2-bit R display signal and the 2-bit I signal.

When the I signals are similarly superposed on G and B, a total of (13×13×13)=2,197 combinations can be obtained. That is, 2,197 gray levels can be displayed by using 6-bit RGB data and 6-bit I signal data.

In the first embodiment described earlier, the circuit configuration of the I signal generating circuit can be the same as the color signal generating circuit. Like this first embodiment, the arrangement of the I signal generating circuit can be the same as the color signal generating circuit shown in FIG. 7A in this embodiment, so this arrangement is not shown. That is, 2-bit digital data is input and held in registers of two bits, and a control circuit outputs I signals of four bits (0, 1, an intermediate potential between 0 and 1, and high impedance).

(Fourth Embodiment)

As the fourth embodiment of the present invention, the whole configuration of an OSD circuit having the circuit described in any of the above first to third embodiments and an image display circuit will be described below.

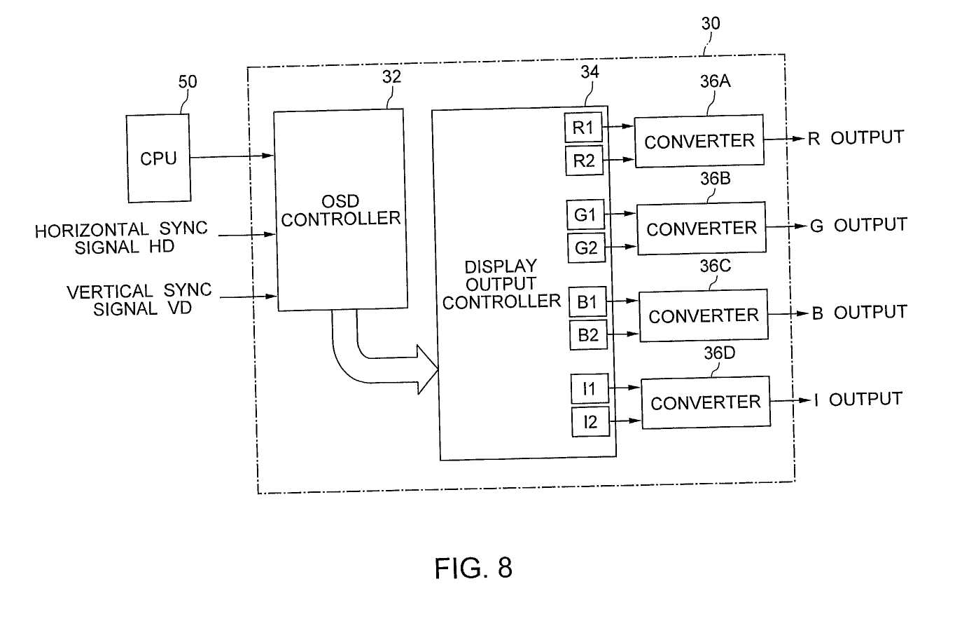

FIG. 8 is a conceptual view showing the entire arrangement of the OSD circuit according to this embodiment. This OSD circuit 30 receives a digital signal from a CPU (Central Processing Unit) 50, also receives a horizontal sync signal HD and a vertical sync signal VD, and forms R (red), G (green), and B (blue) display signals and an I signal output.

More specifically, on the basis of the horizontal sync signal HD and the vertical sync signal VD cut out from a television video signal, the OSD circuit 30 outputs the R, G, B, and I signals as basic signals of OSD display in synchronism with the video signal.

An OSD controller 32 sets color designating registers R1, R2, G1, G2, B1, B2, I1, and I2 of a display signal controller 34 in accordance with a control signal from the CPU 50. By the combination of the set values of these color designating registers, the output voltage levels from converters 35A to 35D in the subsequent stage are determined, and a color tone matching the levels is obtained. Each of the converters 36A to 36D includes the same arrangement as the 2-bit-input, 3-value-output circuit 10 described in the first embodiment or the 2-bit-input, 4-value-output circuit 20 described in the third embodiment. Also, the relationships between the settings of the color designating registers R1 to I2 and the outputs from the converters 36A to 36D are as explained in these embodiments.

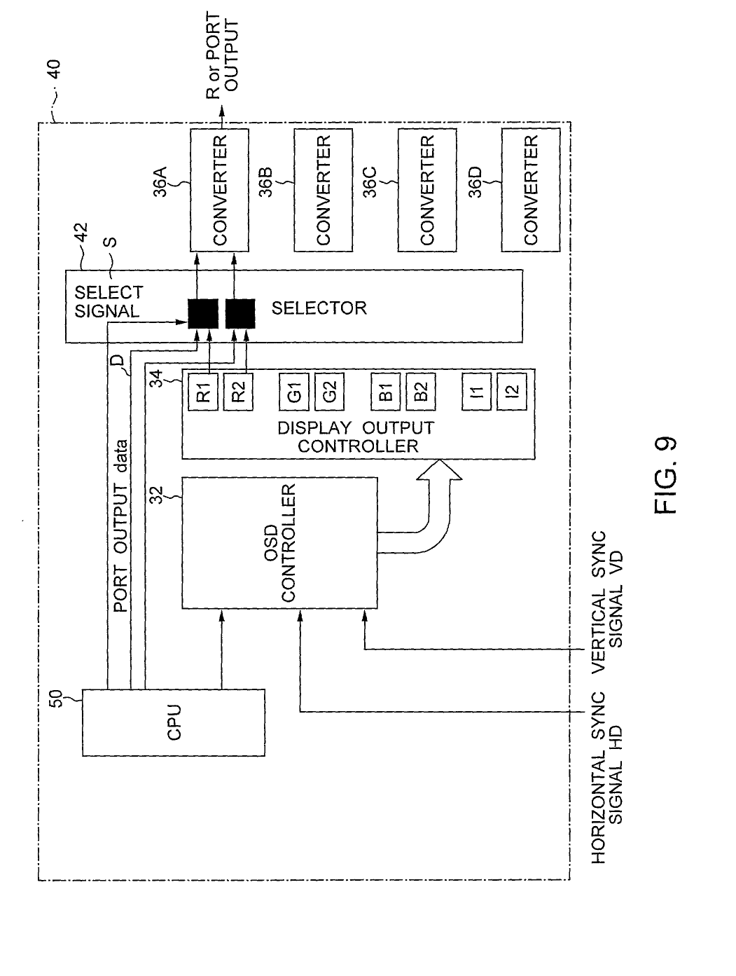

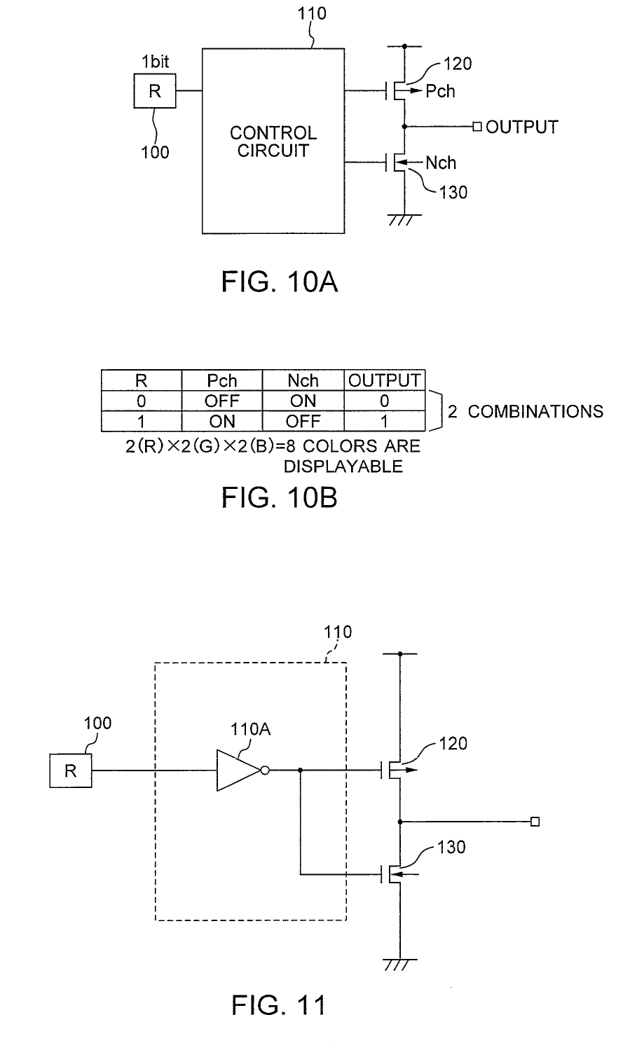

FIG. 9 is a conceptual view showing the whole configuration of an image display circuit according to this embodiment. This image display circuit 40 shown in FIG. 9 comprises an OSD controller 32, a display signal controller 34, a selector 42, converters 36A to 36D, and a CPU 50. The OSD controller 32, the display signal controller 34, and the converters 36A to 36D form the main part of the OSD circuit 30 and operate as described above with reference to FIG. 8.

In this practical example, the selector 42 can appropriately switch input data to the converters 36A to 36D. That is, this selector 42 can receive a select signal S from the CPU 50 and appropriately selectively output, to the converters, port output data from the CPU 50 and data from the color designating registers.

When the data from the color designating registers are supplied to the converters 36A to 36D, 3- or 4-level outputs are formed and output as color display signals in accordance with the embodiments described above.

When the port output data is input to the converters 36A to 36D, 3- or 4-level outputs are similarly formed and output as port output signals.

In this practical example, the selector 42 allows the CPU 50 and the OSD circuit 30 to share the converters 36A to 36D and makes it possible to simplify the circuit configuration for outputting port output signals and color display signals.

Referring to FIGS. 8 and 9, the converters 36A to 36D are connected to the output stage of the OSD circuit 30. However, the present invention is not restricted to this arrangement. For example, the OSD circuit 30 can also be obtained by forming the voltage conversion circuits as shown in FIGS. 4A to 7B in the subsequent stage of the converters 36A to 36D.

The embodiments of the present invention have been described above by taking their practical examples. However, the present invention is not limited to these practical examples. For example, those skilled in the art can appropriately change, by using the known technologies, the designs of practical arrangements of the control circuits 12 and 22 included in the OSD circuit or the voltage conversion circuits formed in the subsequent stages of these control circuits 12 and 22, thereby similarly obtaining the effects described previously.

Also, the OSD circuit of the present invention can achieve the same effects when mounted not only in a television receiver but also in any apparatuses for displaying predetermined images by using various image display apparatuses. Examples are image displays by computers, various information displays, data displays by measurement controllers, and viewfinder displays by video cameras.

As described in detail above, the present invention can display multiple gray levels of 27 or 64 colors from 2-bit R, G, and B digital data with a simple circuit configuration.

Furthermore, the present invention can display multiple gray levels of 79, 253, or a larger number of colors by generating an I signal from 2-bit digital data and superposing the signal.

What is claimed is:

1. An on screen display circuit comprising a color signal generating circuit for receiving 2-bit digital data, forming one of not less than three different outputs on the basis of the digital data, and outputting the formed signal as a color display signal.

2. A circuit according to claim 1, further comprising an I signal generating circuit for receiving 2-bit digital data, forming one of not less than three different outputs on the basis of the digital data, and outputting the formed signal as an I signal to be superposed on the color display signal.

3. A circuit according to claim 1, further comprising a circuit for superposing the color display signal and the I signal.

4. A circuit according to claim 3, wherein said superposing circuit comprises:
a first input terminal connected to an output terminal of said color signal generating circuit;
a second input terminal connected to an output terminal of said I signal generating circuit;
an output terminal for outputting a superposition signal formed by superposing the color display signal and the I signal;
a first resistor connected between said first input terminal and said output terminal;
a second resistor having one terminal connected to said output terminal;
a third resistor having one terminal connected to said second input terminal; and
a switching element having one terminal connected to the other terminal of said second resistor, the other terminal connected to the ground, and a control terminal connected to the other terminal of said third resistor,
wherein the I signal is input to said control terminal to control an opening/closing operation of said switching element, thereby superposing the I signal on the color display signal and outputting the superposition signal from said output terminal.

5. A circuit according to claim 1, wherein the not less than three different outputs are a low level, a high level, and a high impedance.

6. A circuit according to claim 1, wherein the not less than three different outputs are a low level, a high level, a high impedance, and a fourth level higher than the low level and lower than the high level.

7. A circuit according to claim 1, comprising said color signal generating circuit for each of R, G, and B.

8. An image display circuit comprising:
a CPU for outputting a select signal and port output data;
an on screen display circuit according to claim 1; and
a selector for supplying one of the 2-bit digital data and the port output data to said color signal generating circuit on the basis of the select signal,
wherein said color signal generating circuit outputs the color signal when supplied with the 2-bit digital data from said selector, and forms one of not less than three outputs on the basis of the port output data, when supplied with the port output data from said selector, and outputs the formed signal as a port output signal.

9. A circuit according to claim 2, further comprising a circuit for superposing the color display signal and the I signal.

10. A circuit according to claim 2, wherein the not less than three different outputs are a low level, a high level, and a high impedance.

11. A circuit according to claim 2, wherein the not less than three different outputs are a low level, a high level, a high impedance, and a fourth level higher than the low level and lower than the high level.

12. A circuit according to claim 2, comprising said color signal generating circuit for each of R, G, and B.

13. An image display circuit comprising:
a CPU for outputting a select signal and port output data;
an on screen display circuit according to claim 2; and
a selector for supplying one of the 2-bit digital data and the port output data to said color signal generating circuit on the basis of the select signal,
wherein said color signal generating circuit outputs the color signal when supplied with the 2-bit digital data from said selector, and forms one of not less than three outputs on the basis of the port output data, when supplied with the port output data from said selector, and outputs as a port output signal.

14. A circuit according to claim 3, wherein the not less than three different outputs are a low level, a high level, and a high impedance.

15. A circuit according to claim 3, wherein the not less than three different outputs are a low level, a high level, a high impedance, and a fourth level higher than the low level and lower than the high level.

16. A circuit according to claim 3, comprising said color signal generating circuit for each of R, G, and B.

17. An image display circuit comprising:
a CPU for outputting a select signal and port output data;
an on screen display circuit according to claim 3; and
a selector for supplying one of the 2-bit digital data and the port output data to said color signal generating circuit on the basis of the select signal,
wherein said color signal generating circuit outputs the color signal when supplied with the 2-bit digital data from said selector, and forms one of not less than three outputs on the basis of the port output data, when supplied with the port output data from said selector, and outputs as a port output signal.

18. A circuit according to claim 5, comprising said color signal generating circuit for each of R, G, and B.

19. An image display circuit comprising:
a CPU for outputting a select signal and port output data;
an on screen display circuit according to claim 5; and
a selector for supplying one of the 2-bit digital data and the port output data to said color signal generating circuit on the basis of the select signal,
wherein said color signal generating circuit outputs the color signal when supplied with the 2-bit digital data from said selector, and forms one of not less than three outputs on the basis of the port output data, when supplied with the port output data from said selector, and outputs as a port output signal.

20. An image display circuit comprising:
a CPU for outputting a select signal and port output data;
an on screen display circuit according to claim 6; and
a selector for supplying one of the 2-bit digital data and the port output data to said color signal generating circuit on the basis of the select signal,
wherein said color signal generating circuit outputs the color signal when supplied with the 2-bit digital data from said selector, and forms one of not less than three outputs on the basis of the port output data, when supplied with the port output data from said selector, and outputs as a port output signal.
